(19) United States
(12) Patent Application Publication
(10) Pub. No.: US 2019/0080270 A1
(43) Pub. Date: Mar. 14, 2019

(54) PRODUCTION SCHEDULING METHOD AND SYSTEM BASED ON IMPROVED ARTIFICIAL BEE COLONY ALGORITHM AND STORAGE MEDIUM

(71) Applicant: Hefei University of Technology, Hefei (CN)

(72) Inventors: Xinbao Liu, Hefei (CN); Jun Pei, Hefei (CN); Shaojun Lu, Hefei (CN); Min Kong, Hefei (CN); Xiaofei Qian, Hefei (CN); Zhiping Zhou, Hefei (CN)

(21) Appl. No.: 16/127,124

(22) Filed: Sep. 10, 2018

(30) Foreign Application Priority Data
Sep. 11, 2017 (CN) 201710811741.1

(51) Int. Cl. G06Q 10/06; G05B 19/418

(52) U.S. Cl. CPC G06Q 10/06311; G05B 2219/32283; G05B 19/41865

(57) ABSTRACT

The present invention disclose a parallel machine batch scheduling method and system based on an improved artificial bee colony algorithm in a deterioration situation. With this method, a near-optimal solution for the parallel machine batch scheduling problem with deteriorating jobs and maintenance consideration can be obtained. The model of the present invention is derived from an actual production process with considerations of machine maintenance and batching as well as additional processing and maintenance time for jobs and machines over time in actual production. According to the present invention, the settlement of this problem is conducive to providing reliable decision support for the production and maintenance of an enterprise in complex real production conditions, thus reducing enterprise operation costs, increasing enterprise productivity, and promoting building of a modern smart factory of the enterprise.

### CROSS-REFERENCE TO RELATED APPLICATIONS

This application claims to Chinese application No. 201710811741.1 with a filing date of Sep. 11, 2017. The content of the aforementioned applications, including any intervening amendments thereto, are incorporated herein by reference.

### TECHNICAL FIELD

The present invention relates to the technical field of software, and more particularly, to a production scheduling method and system based on an improved artificial bee colony algorithm and a storage medium.

### BACKGROUND OF THE PRESENT INVENTION

The scheduling problem with deteriorating jobs, initially posed by Gupta and Gupta (1988), is a typical combinatorial optimization problem that has been widely valued and studied in recent years. It has been widely found in various industries of modern production, for example, in the fields such as steel and iron processing industry, healthcare industry and environmental governance. Unlike fixed processing time of each job in the traditional scheduling problem, in a deterioration situation, the earlier the processing is started, the shorter the processing duration of a job is. Moreover, in actual production, a machine can usually process a particular number of jobs at the same time. To guarantee continuous effectiveness of a machine and the quality level of products, maintenance of the machine is needed during processing. The design of a corresponding job and maintenance arrangement rule with reasonable and effective utilization of the job processing law will significantly boost the productivity of an enterprise and improve the market competitiveness of the enterprise in current complex conditions. Therefore, it is of great practical significance to study the parallel machine batch scheduling problem with maintenance consideration in a deterioration situation.

In previous studies, intelligent algorithms were extensively applied to solve various parallel machine scheduling problem. There has been developed a method to solve the parallel machine scheduling problem in general situation using a genetic algorithm. There has been developed another method to solve the parallel machine scheduling problem in fuzzy environment using a particle swarm optimization algorithm. Further, a method involving a hybrid genetic particle swarm optimization algorithm has been developed on the basis of the former study, and the hybrid algorithm has been proven by experiments to be superior to the former in both search capability and robustness.

However, during the process of invention-creation, the inventor has found that the prior art has some disadvantages as follows: in a traditional scheduling model, it is typically assumed that the processing time of a job is fixed and known. But in complex production conditions, the processing time of a job may extend over time due to the deterioration of machines and the fatigue of human. In addition, a machine may be under maintenance during processing. Although many documents about study on the machine scheduling problem under deterioration have been published in recent years, study with considerations of deterioration and parallel batch processing machines is rarely reported. Besides, by document investigation, it is found that no researcher has built a complex scheduling model with considerations of deterioration, maintenance, parallel batch processing and unrelated parallel machines. However, such factors may be present simultaneously in actual production conditions. The settlement of this complex problem is the key to solve hard enterprise production problems, and the traditional scheduling model cannot solve this problem. In addition to this, methodologically, while having the disadvantage of easily plunging into local optimum, the artificial bee colony algorithm would exhibit good performance when combined with other intelligent algorithms, including with a heuristic algorithm in some specific problems. The traditional artificial bee colony algorithm can hardly be applied to solve current complex production problems.

### SUMMARY OF THE PRESENT INVENTION

The present invention provides a production scheduling method and system based on an improved artificial bee colony algorithm and a storage medium to solve at least one of the above technical problems.

In a first aspect, an embodiment of the present invention provides a production scheduling method based on an improved artificial bee colony algorithm. The method is executed by a computer and includes:

S1, inputting the capacity of each machine and general processing time for a job, and setting parameters of the improved artificial bee colony algorithm, including maximum iterations tₘₐₓ, global optimal solution gbest, nectar source search limit UP, number of employed bees SN, and iteration t=1;

S2, initializing the population with consideration of total SN nectar sources, with the position of the qth nectar source being defined as X_{q}=(x_{q}¹, x_{q}², . . . , x_{q}^{j}, . . . , x_{q}ⁿ), q=1, 2, . . . , SN, wherein x_{q}^{j} represents the position of the qth nectar source in the jth dimension, indicating that the jth job is assigned to machine x_{q}^{j};

S3, calculating a fitness value of each nectar source in a solution set, and updating the global optimal solution gbest;

S4, calculating neighborhood selection probability

$${R}_{a} = \frac{t}{{t}_{max}}$$

of the current generation, by setting the variable q=1;

S5, determining whether rand(0,1)≤Rₐ is true; if yes, performing an exchange mutation operation on X_{q}, and retaining the nectar source according to a greedy rule, wherein rand(0,1) represents a random number between 0 and 1; otherwise, performing an inversion mutation operation on X_{q}, and retaining nectar source according to the greedy rule; if the nectar source is updated, up_{q}=0; otherwise, up_{q}=up_{q}+1, wherein up_{q} represents searches for the qth nectar source;

S6, with q=q+1, determining whether q≤SN is true; if yes, returning to the step S5; otherwise, performing step S7;

S7, calculating probability

$${pro}_{q} = \frac{1 / {fit}_{q}}{{\sum }_{z = 1}^{SN} 1 / {fit}_{z}} ,$$

wherein fit_{q} represents the fitness value of the qth nectar source, and smaller fit_{q} indicates a better solution since the problem to be solved is a minimization problem;

S8, selecting the qth nectar source from the population with the probability pro_{q}, and performing a tabu search operation; if the nectar source is updated, up_{q}=0; otherwise, up_{q}=up_{q}+1; repeating this operation SN times to update the solution set;

S9, setting the variable q=1;

S10, if up_{q}≤UP, q=q+1; otherwise, replacing X_{q} with a randomly generated new solution, and let up_{q}=0, q=q+1;

S11, determining whether q≤SN is true; if yes, returning to the step S10; otherwise, performing step S12; and

S12, replacing later 20% nectar sources in the solution set with randomly generated nectar sources; let t=t+1; determining whether t≤tₘₐₓ is true; if yes, returning to the step S3; otherwise, terminating the algorithm and outputting the global optimal solution gbest, and outputting optimal job assignment, job batching, batch processing order and starting time of maintenance on each machine.

In a second aspect, an embodiment of the present invention provides a production scheduling system based on an improved artificial bee colony algorithm.

The system includes a computer including:

at least one storage unit;

at least one processing unit; and

at least one output unit;

The at least one storage unit stores at least one instruction to be loaded and executed by the at least one processing unit to implement the following steps:

S1, inputting the capacity of each machine and general processing time for a job, and setting parameters of the improved artificial bee colony algorithm, including maximum iterations tₘₐₓ, global optimal solution gbest, nectar source search limit UP, number of employed bees SN, and iteration t=1;

S2, initializing the population with consideration of total SN nectar sources, with the position of the qth nectar source being defined as X_{q}=(x_{q}¹, x_{q}², . . . , x_{q}^{j}, . . . , x_{q}ⁿ), q=1, 2, . . . , SN, wherein x_{q}^{j} represents the position of the qth nectar source in the jth dimension, indicating that the jth job is assigned to machine x_{q}^{j};

S3, calculating a fitness value of each nectar source in a solution set, and updating the global optimal solution gbest;

S4, calculating neighborhood selection probability

$${R}_{a} = \frac{t}{{t}_{max}}$$

of the current generation, by setting the variable q=1;

S5, determining whether rand(0,1)≤Rₐ is true; if yes, performing an exchange mutation operation on X_{q}, and retaining the nectar source according to a greedy rule, wherein rand(0,1) represents a random number between 0 and 1; otherwise, performing an inversion mutation operation on X_{q}, and retaining nectar source according to the greedy rule; if the nectar source is updated, up_{q}=0; otherwise, up_{q}=up_{q}+1, wherein up_{q} represents searches for the qth nectar source;

S6, with q=q+1, determining whether q≤SN is true; if yes, returning to the step S5; otherwise, performing step S7;

S7, calculating probability

$${pro}_{q} = \frac{1 / {fit}_{q}}{{\sum }_{z = 1}^{SN} 1 / {fit}_{z}} ,$$

wherein fit_{q} represents the fitness value of the qth nectar source, and smaller fit_{q} indicates a better solution since the problem to be solved is a minimization problem;

S8, selecting the qth nectar source from the population with the probability pro_{q}, and performing a tabu search operation; if the nectar source is updated, up_{q}=0; otherwise, up_{q}=up_{q}+1; repeating this operation SN times to update he solution set;

S9, setting the variable q=1;

S10, if up_{q}≤UP, q=q+1; otherwise, replacing X_{q} with a randomly generated new solution, and let up_{q}=0, q=q+1;

S11, determining whether q≤SN is true; if yes, returning to the step S10; otherwise, performing step S12; and

S12, replacing later 20% nectar sources in the solution set with randomly generated nectar sources; let t=t+1, determining whether t≤tₘₐₓ is true; if yes, returning to the step S3; otherwise, terminating the algorithm.

The at least one output unit is configured to output the global optimal solution gbest, and output optimal job assignment, job batching, batch processing order and starting time of maintenance on each machine.

In a third aspect, the present invention provides a computer-readable storage medium that stores at least one instruction to be loaded and executed by a processor to implement the above method.

According to the embodiments of the present invention, a near-optimal solution for the parallel machine batch scheduling problem with deteriorating jobs and maintenance consideration can be obtained. The model of the present invention is derived from an actual production process with considerations of machine maintenance and batching as well as additional processing and maintenance time for jobs and machines over time in actual production. According to the present invention, the settlement of this problem is conducive to providing reliable decision support for the production and maintenance of an enterprise in complex real production conditions, thus reducing enterprise operation costs, increasing enterprise productivity, and promoting building of a modern smart factory of the enterprise.

### BRIEF DESCRIPTION OF THE DRAWINGS

Various other advantages and benefits will become obvious for those of ordinary skill in the art from the following detailed descriptions of preferred embodiments. The accompanying drawings are merely intended to illustrate the preferred embodiments rather than limit the invention. Furthermore, like reference numerals indicate like components throughout the drawings in which:

FIG. 1 is a schematic diagram of a parallel machine batch scheduling problem with maintenance consideration in accordance with an embodiment of the present invention;

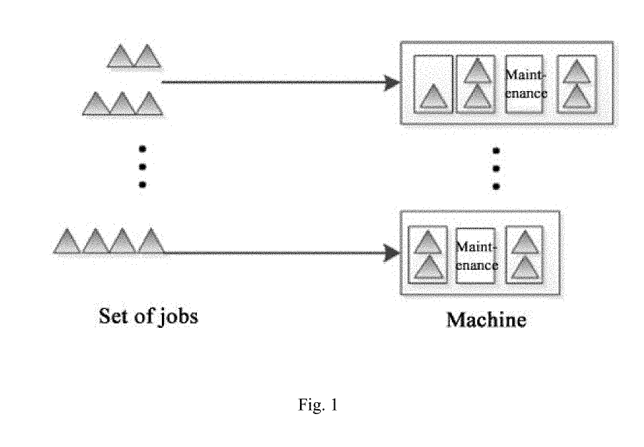

FIG. 2 is a flowchart of a production scheduling method based on an improved artificial bee colony algorithm in accordance with an embodiment of the present invention; and

FIG. 3 is a structure diagram of a production scheduling system based on an improved artificial bee colony algorithm in accordance with an embodiment of the present invention.

### DETAILED DESCRIPTION OF THE PRESENT INVENTION

Technical solutions in the embodiments of the present invention will be described clearly and fully below in combination with the drawings accompanying the embodiments of the present invention. It is apparent that the described embodiments are merely part of embodiments of the present invention, rather than all. Other embodiments achieved by those of ordinary skill in the art based on the embodiments in the present invention without creative work shall all fall into the scope of protection of the present invention.

The embodiments of the present invention are meant to solve the parallel machine batch scheduling problem with maintenance consideration in a deterioration situation with the purpose of determining a specific machine to which each job will be assigned, the batching of jobs on the machine, the processing order of a batch and start time of maintenance. Based on the characteristics of the problem, an effective hybrid algorithm is developed by theoretical analysis and mathematical derivation to solve the combinatorial optimization problem, providing a new method for the management of an enterprise production schedule in complex conditions.

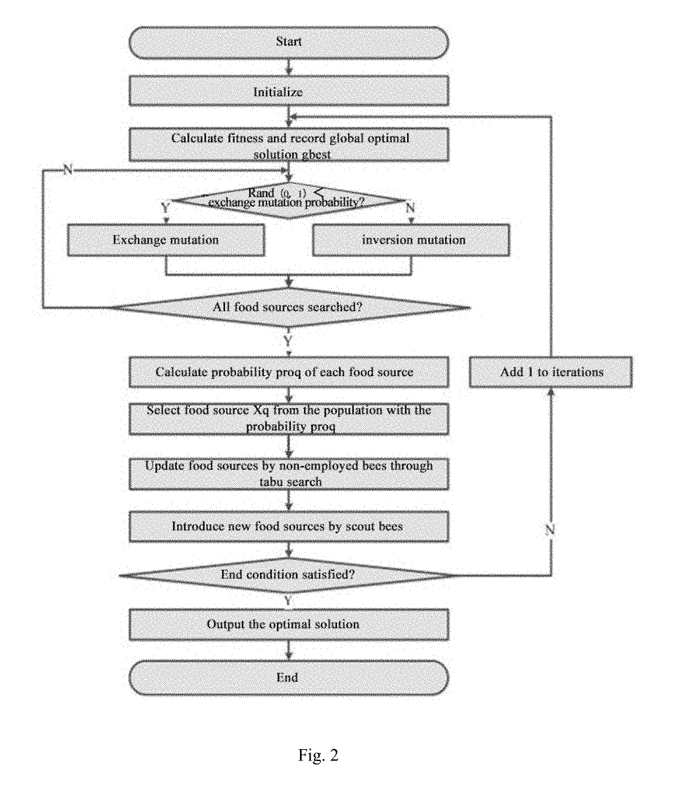

On this basis, one embodiment of the present invention provides a production scheduling method based on an improved artificial bee colony algorithm. The method is executed by a computer, as shown in FIG. 2, and includes:

S1, inputting the capacity of each machine and general processing time for a job, and setting parameters of the improved artificial bee colony algorithm, including maximum iterations tₘₐₓ, global optimal solution gbest, nectar source search limit UP, number of employed bees SN, and iteration t=1;

S2, initializing the population with consideration of total SN nectar sources, with the position of the qth nectar source being defined as X_{q}=(x_{q}¹, x_{q}², . . . , x_{q}^{j}, . . . , x_{q}ⁿ), q=1, 2, . . . , SN, wherein x_{q}^{j} represents the position of the qth nectar source in the jth dimension, indicating that the jth job is assigned to machine x_{q}^{j};

S3, calculating a fitness value of each nectar source in a solution set, and updating the global optimal solution gbest;

S4, calculating neighborhood selection probability

$${R}_{a} = \frac{t}{{t}_{max}}$$

of the current generation, by setting the variable q=1;

S5, determining whether rand(0,1)≤Rₐ is true; if yes, performing an exchange mutation operation on X_{q}, and retaining the nectar source according to a greedy rule, wherein rand(0,1) represents a random number between 0 and 1; otherwise, performing an inversion mutation operation on X_{q}, and retaining nectar source according to the greedy rule; if the nectar source is updated, up_{q}=0; otherwise, up_{q}=up_{q}+1, wherein up_{q} represents searches for the qth nectar source;

S6, with q=q+1, determining whether q≤SN is true; if yes, returning to the step S5; otherwise, performing step S7;

S7, calculating probability

$${pro}_{q} = \frac{1 / {fit}_{q}}{{\sum }_{z = 1}^{SN} 1 / {fit}_{z}} ,$$

wherein fit_{q} represents the fitness value of the qth nectar source, and smaller fit_{q} indicates a better solution since the problem to be solved is a minimization problem;

S8, selecting the qth nectar source from the population with the probability pro_{q}, and performing a tabu search operation; if the nectar source is updated, up_{q}=0; otherwise, up_{q}=up_{q}+1; repeating this operation SN times to update the solution set;

S9, setting the variable q=1;

S10, if up_{q}≤UP, q=q+1; otherwise, replacing X_{q} with a randomly generated new solution, and let up_{q}=0, q=q+1;

S11, determining whether q≤SN is true; if yes, returning to the step S10; otherwise, performing step S12; and

S12, replacing later 20% nectar sources in the solution set with randomly generated nectar sources; let t=t+1; determining whether t≤tₘₐₓ is true; if yes, returning to the step S3; otherwise, terminating the algorithm and outputting the global optimal solution gbest, and outputting optimal job assignment, job batching, batch processing order and starting time of maintenance on each machine.

According to this embodiment of the present invention, a near-optimal solution for the parallel machine batch scheduling problem with deteriorating jobs and maintenance consideration can be obtained. The model of the present invention is derived from an actual production process with considerations of machine maintenance and batching as well as additional processing and maintenance time for jobs and machines over time in actual production. According to the present invention, the settlement of this problem is conducive to providing reliable decision support for the production and maintenance of an enterprise in complex real production conditions, thus reducing enterprise operation costs, increasing enterprise productivity, and promoting building of a modern smart factory of the enterprise.

In specific implementation, calculating the fitness value of each nectar source in the solution set in the step S3 may include:

step S31, successively assigning the jth job to machine x_{q}^{j} according to a code rule first, and on each machine, sorting the jobs in a non-decreasing order by the general processing time;

step S32, on each machine, arranging first

$${n}_{i} - ( ⌈ \frac{{n}_{i}}{c} ⌉ - 1 ) c$$

jobs into a first batch and deleting such jobs from a job list; then arranging first c jobs in the remaining list into a batch and deleting such jobs from the job list, and so on, until all jobs in the job list are arranged completely, wherein nᵢ represents the number of jobs on the ith machine, while c represents the number of jobs that a machine is able to process simultaneously, and

$$⌈ \frac{x}{y} ⌉$$

represents the smallest integer that is not less than

$$\frac{x}{y} ;$$

step S33, setting parameter e=1, indicating that maintenance is started after the completion of processing of the first job;

step S34, with regard to each machine, calculating

$${w}_{hi} = \{ \begin{matrix}( {d}_{i} + 1 ) {( β + 1 )}^{e - h} h = 1 , 2 , 3 … , e \\ {( β + 1 )}^{e - h} h = 1 , 2 , 3 , … , {B}_{i}\end{matrix} , i = 1 , … , m ,$$

wherein Bᵢ represents the total number of batches on the ith machine;

step S35, sorting all batches on each machine in a non-decreasing order by processing time, arranging the first batch in a position with the maximum value of wₕᵢ, i.e., arranging the first job to be processed as the hth one, and deleting this batch and wₕᵢ from the list; and repeating this operation until each batch corresponds to the processing order one to one; and

step S36, calculating completion time Cₘₐₓⁱ(e) on each machine; let e=e+1, determining whether e≤Bᵢ is true; if yes, returning to the step S34; otherwise, confirming on the machine that maintenance is started after the completion of processing of the (L*)th job, wherein L*=Arg max_{L=1,2, . . . ,B}_{ᵢ} {Cₘₐₓⁱ(L)}, i.e., arranging the position with the shortest processing time among all positions to be the position of maintenance, and terminating the algorithm.

In specific implementation, the step S5 may include:

step S51, obtaining a nectar source code, and generating a random number rand between 0 and 1;

step S52, determining whether rand<Rₐ is true; if yes, performing step S53; otherwise, performing step S54;

step S53, randomly generating two positive integers x and y between 1 and n, and interchanging numerical values corresponding to the xth and yth positions in the nectar source, thereby obtaining a new nectar source position code; and

step S54, randomly generating two positive integers x and y between 1 and n, and reversing a sequence between the xth and yth position, thereby obtaining a new nectar source position code.

In specific implementation, the step S7 may include:

step S71, obtaining a nectar source code as current optimal solution, and defining iterations it max, tabu list length tabulong, and neighborhood searches Slong;

step S72, randomly generating two positive integers x and y between 1 and n, moving the numerical value of the xth position to the yth position, and then arranging numerical values between the (x+1)th and the yth position to the xth to (y−1)th positions of a new code, thereby obtaining a new nectar source code;

step S73, repeating the step S72 until Slong new nectar source codes are generated, and calculating the fitnesses of all solutions;

step S74, comparing the solution with the best fitness with the current optimal solution; if the solution with the best fitness is superior to the current optimal solution, performing step S76; otherwise, performing step S75;

step S75, sorting all the solutions in a descending order, successively checking whether the respective x and y values of the solutions are present in the tabu list until the result for a solution is no, and then performing step S76 with the solution as the best-fit solution;

step S76, replacing the current optimal solution with the best-fit solution; determining whether the number of records in the tabu list is greater than tabulong; if yes, deleting the last element in the tabu list, moving each element down by one position, and adding the x and y values corresponding to the best-fit solution to the first position of the tabu list; otherwise, directly moving each element down by one position, and adding the x and y values corresponding to the best-fit solution to the first position of the tabu list; and

step S77, with it=it+1, determining whether it≤it max is true; if yes, returning to the step S72; otherwise, terminating search.

The present invention has the following advantages:

1. The present invention is aimed at the parallel machine batch scheduling problem with deteriorating jobs and maintenance consideration. By the improved artificial bee colony algorithm, jobs are firstly assigned to different machines by the means of codes. Then, an arrangement strategy with regard to job batching, sorting and maintenance for each machine is put forward according to the nature of the problem, and the optimal productive maintenance solution on each machine is obtained in polynomial time. Next, an adaptive neighborhood search operation is performed on each nectar source. Systematic updating based on tatu search is carried out selectively on the basis of the fitnesses of the nectar sources. By repeated iterations, continuous updating of the population is achieved, and the optimal solution is obtained eventually. The improved artificial bee colony algorithm is a highly efficient algorithm in convergence rate and convergence result. By this algorithm, the parallel machine batch scheduling problem with deteriorating jobs and maintenance consideration is solved and the enterprise productivity in actual complex conditions is improved, providing effective decision support for an enterprise and being conductive to speed up the intelligent development of the enterprise.

2. The present invention provides the optimal algorithm for batching and sorting jobs and arranging maintenance on each particular machine in the deterioration situation, ensuring that the production capability of each machine can be brought into full play, i.e., the optimization of the processing schedule on each machine is achieved, after the completion of the process of assigning a set of jobs to machines.

3. While a general artificial bee colony algorithm has the problem of easily plunging into local optimum, the artificial bee colony algorithm exhibits good performance when combined with a plurality of algorithms in use. According to the present invention, an adaptive neighborhood search mechanism is designed with regard to the disadvantages and advantages of the artificial bee colony algorithm in combination with specific use thereof in this problem, and the search capability of follower bees is enhanced by a tabu search algorithm so as to guarantee the updating efficiency of nectar sources. Thus, the convergence rate of the algorithm and the diversity of solutions are increased effectively, and the local convergence capability in the last phase of the algorithm is enhanced to a certain extent.

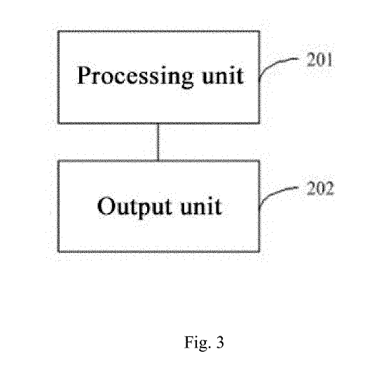

Based on the inventive concept, another embodiment of the present invention provides a production scheduling system based on an improved artificial bee colony algorithm. As shown in FIG. 3, the scheduling system includes a computer including:

at least one storage unit 201;

at least one processing unit 202; and

at least one output unit (not shown in the figure).

The processing unit may be, for example, a processor. The storage unit may be, for example, a memory. The output unit may be, for example, an output device formed by a data interface and a data cable. The output unit can output data to a display screen, other electronic devices and the like.

The at least one storage unit stores at least one instruction to be loaded and executed by the at least one processing unit to implement the following steps:

S1, inputting the capacity of each machine and general processing time for a job, and setting parameters of the improved artificial bee colony algorithm, including maximum iterations tₘₐₓ, global optimal solution gbest, nectar source search limit UP, number of employed bees SN, and iteration t=1;

S2, initializing the population with consideration of total SN nectar sources, with the position of the qth nectar source being defined as X_{q}=(x_{q}¹, x_{q}², . . . , x_{q}^{j}, . . . , x_{q}ⁿ), q=1, 2, . . . , SN, wherein x_{q}^{j} represents the position of the qth nectar source in the jth dimension, indicating that the jth job is assigned to machine x_{q}^{j};

S3, calculating a fitness value of each nectar source in a solution set, and updating the global optimal solution gbest;

S4, calculating neighborhood selection probability

$${R}_{a} = \frac{t}{{t}_{max}}$$

of the current generation, by setting the variable q=1;

S5, determining whether rand(0,1)≤Rₐ is true; if yes, performing an exchange mutation operation on X_{q}, and retaining the nectar source according to a greedy rule, wherein rand(0,1) represents a random number between 0 and 1; otherwise, performing an inversion mutation operation on X_{q}, and retaining nectar source according to the greedy rule; if the nectar source is updated, up_{q}=0; otherwise, up_{q}=up_{q}+1, wherein up_{q} represents searches for the qth nectar source;

S6, with q=q+1, determining whether q≤SN is true; if yes, returning to the step S5; otherwise, performing step S7;

S7, calculating probability

$${pro}_{q} = \frac{1 / {fit}_{q}}{{\sum }_{z = 1}^{SN} 1 / {fit}_{z}} ,$$

wherein fit_{q} represents the fitness value of the qth nectar source, and smaller fit_{q} indicates a better solution since the problem to be solved is a minimization problem;

S8, selecting the qth nectar source from the population with the probability pro_{q}, and performing a tabu search operation; if the nectar source is updated, up_{q}=0; otherwise, up_{q}=up_{q}+1; repeating this operation SN times, and updating the solution set;

S9, setting the variable q=1;

S10, if up_{q}≤UP, q=q+1; otherwise, replacing X_{q} with a randomly generated new solution, and let up_{q}=0, q=q+1;

S11, determining whether q≤SN is true; if yes, returning to the step S10; otherwise, performing step S12; and

S12, replacing later 20% nectar sources in the solution set with randomly generated nectar sources; let t=t+1; determining whether t≤tₘₐₓ is true; if yes, returning to the step S3; otherwise, terminating the algorithm.

The at least one output unit 202 is configured to output the global optimal solution gbest, and output optimal job assignment, job batching, batch processing order and starting time of maintenance on each machine.

Alternatively, the at least one processing unit 201 calculates the fitness value of each nectar source in the solution set in the step S3, which may specifically include:

step S31, successively assigning the jth job to machine x_{q}^{j} according to a code rule first, and on each machine, sorting the jobs in a non-decreasing order by the general processing time;

step S32, on each machine, arranging first

$${n}_{i} - ( ⌈ \frac{{n}_{i}}{c} ⌉ - 1 ) c$$

jobs into a first batch and deleting such jobs from a job list; then arranging first c jobs in the remaining list into a batch and deleting such jobs from the job list, and so on, until all jobs in the job list are arranged completely, wherein nᵢ represents the number of jobs on the ith machine, while c represents the number of jobs that a machine is able to process simultaneously, and

$$⌈ \frac{x}{y} ⌉$$

represents the smallest integer that is not less than

$$\frac{x}{y} ;$$

step S33, setting parameter e=1, indicating that maintenance is started after the completion of processing of the first job;

step S34, with regard to each machine, calculating

$${w}_{hi} = \{ \begin{matrix}( {d}_{i} + 1 ) {( β + 1 )}^{e - h} h = 1 , 2 , 3 … , e \\ {( β + 1 )}^{e - h} h = 1 , 2 , 3 , … , {B}_{i}\end{matrix} , i = 1 , … , m ,$$

wherein Bᵢ represents the total number of batches on the ith machine;

step S35, sorting all batches on each machine in a non-decreasing order by processing time, arranging the first batch in a position with the maximum value of wₕᵢ, i.e., arranging the first job to be processed as the hth one, and deleting this batch and wₕᵢ from the list; and repeating this operation until each batch corresponds to the processing order one to one; and

step S36, calculating completion time Cₘₐₓⁱ(e) on each machine; let e=e+1, determining whether e≤Bᵢ is true; if yes, returning to the step S34; otherwise, confirming on the machine that maintenance is started after the completion of processing of the (L*)th job, wherein L*=Arg max_{L=1,2 . . . ,B}_{ᵢ}{Cₘₐₓⁱ(L)}, i.e., arranging the position with the shortest processing time among all positions to be the position of maintenance, and terminating the algorithm.

Alternatively, the at least one processing unit 201 performs the step S5, which may specifically include:

step S51, obtaining a nectar source code, and generating a random number rand between 0 and 1;

step S52, determining whether rand<Rₐ is true; if yes, performing step S53; otherwise, performing step S54;

step S53, randomly generating two positive integers x and y between 1 and n, and interchanging numerical values corresponding to the xth and yth positions in the nectar source, thereby obtaining a new nectar source position code; and

step S54, randomly generating two positive integers X and y between 1 and n, and reversing a sequence between the xth and yth position, thereby obtaining a new nectar source position code.

Alternatively, the at least one processing unit 201 performs the step S7, which may specifically include:

step S71, obtaining a nectar source code as current optimal solution, and defining iterations it max, tabu list length tabulong, and neighborhood searches Slong;

step S72, randomly generating two positive integers x and y between 1 and n, moving the numerical value of the xth position to the yth position, and then arranging numerical values between the (x+1)th and the yth position to the xth to (y−1)th positions of a new code, thereby obtaining a new nectar source code;

step S73, repeating the step S72 until Slong new nectar source codes are generated, and calculating the fitnesses of all solutions;

step S74, comparing the solution with the best fitness with the current optimal solution; if the solution with the best fitness is superior to the current optimal solution, performing step S76; otherwise, performing step S75;

step S75, sorting all the solutions in a descending order, successively checking whether the respective x and y values of the solutions are present in the tabu list until the result for a solution is no, and then performing step S76 with the solution as the best-fit solution;

step S76, replacing the current optimal solution with the best-fit solution; determining whether the number of records in the tabu list is greater than tabulong; if yes, deleting the last element in the tabu list, moving each element down by one position, and adding the x and y values corresponding to the best-fit solution to the first position of the tabu list; otherwise, directly moving each element down by one position, and adding the x and y values corresponding to the best-fit solution to the first position of the tabu list; and step S77, with it=it+1, determining whether it≤it max is true; if yes, returning to the step S72; otherwise, terminating search.

Since the production scheduling system based on the improved artificial bee colony algorithm introduced in this embodiment can execute the production scheduling method based on the improved artificial bee colony algorithm according to the embodiment of the present invention, those skilled in the art can understand specific embodiments of the production scheduling system based on the improved artificial bee colony algorithm according to this embodiment and various variations thereof based on the production scheduling method based on the improved artificial bee colony algorithm introduced in the embodiment of the present invention. Thus, how the production scheduling system based on the improved artificial bee colony algorithm implements the production scheduling system based on the improved artificial bee colony algorithm in the embodiment of the present invention will not be introduced in detail herein. Any implementation of the system employed in the production scheduling method based on the improved artificial bee colony algorithm in the embodiment of the present invention by those skilled in the art shall fall into the scope of protection of the present application.

An embodiment of the present invention also provides a computer-readable storage medium that stores at least one instruction to be loaded and executed by a processor to implement the above scheduling method.

Numerous specific details are provided in the description herein. However, it can be understood that the embodiments of the present disclosure may be practiced without these specific details. In some examples, well-known methods, structures and techniques are not shown in detail in order not to obscure the understanding of this description.

Similarly, it should be appreciated that in the foregoing descriptions of the example embodiments of the present disclosure, various features of the present disclosure are sometimes grouped together in a single embodiment, figure, or description thereof for the purpose of streamlining the disclosure and aiding in the understanding of one or more of the various inventive aspects. However, the method of the present disclosure is not to be interpreted as reflecting an intention that the claimed disclosure requires more features that are expressly contained in each claim. Rather, as the following claims reflect, inventive subject matter lies in less than all features of a single embodiment as disclosed above. Thus, the claims following the detailed description are hereby expressly incorporated into the detailed description, with each claim standing on its own as a separate embodiment of the present disclosure.

What is claimed is:

1. A production scheduling method based on an improved artificial bee colony algorithm, the method being executed by a computer and comprising:
S1, inputting the capacity of each machine and general processing time for a job, and setting parameters of the improved artificial bee colony algorithm, including maximum iterations tₘₐₓ, global optimal solution gbest, nectar source search limit UP, number of employed bees SN, and iteration t=1;
S2, initializing the population with consideration of total SN nectar sources, with the position of the qth nectar source being defined as X_{q}=(x_{q}¹, x_{q}², . . . , x_{q}^{j}, . . . , x_{q}ⁿ), q=1, 2, . . . , SN, wherein x_{q}^{j} represents the position of the qth nectar source in the jth dimension, indicating that the jth job is assigned to machine x_{q}^{j};
S3, calculating a fitness value of each nectar source in a solution set, and updating the global optimal solution gbest;
S4, calculating neighborhood selection probability
$${R}_{a} = \frac{t}{{t}_{max}}$$
of the current generation, by setting the variable q=1;
S5, determining whether rand(0,1) Rₐ is true; if yes, performing an exchange mutation operation on X_{q}, and retaining the nectar source according to a greedy rule, wherein rand(0,1) represents a random number between 0 and 1; otherwise, performing an inversion mutation operation on X_{q}, and retaining nectar source according to the greedy rule; if the nectar source is updated, up_{q}=0; otherwise, up_{q}=up_{q}+1, wherein up_{q} represents searches for the qth nectar source;
S6, with q=q+1, determining whether q≤SN is true; if yes, returning to the step S5; otherwise, performing step S7;
S7, calculating probability
$${pro}_{q} = \frac{1 \text{/} {fit}_{q}}{{\sum }_{z = 1}^{SN} 1 \text{/} {fit}_{z}} ,$$
wherein fit_{q} represents the fitness value of the qth nectar source, and smaller fit_{q} indicates a better solution since the problem to be solved is a minimization problem;
S8, selecting the qth nectar source from the population with the probability pro_{q}, and performing a tabu search operation; if the nectar source is updated, up_{q}=0; otherwise, up_{q}=up_{q}+1; repeating this operation SN times to update the solution set;
S9, setting the variable q=1;
S10, if up_{q}≤UP, q=q+1; otherwise, replacing X_{q} with a randomly generated new solution, and let up_{q}=0, q=q+1;
S11, determining whether q≤SN is true; if yes, returning to the step S10; otherwise, performing step S12; and
S12, replacing later 20% nectar sources in the solution set with randomly generated nectar sources; let t=t+1; determining whether t≤tₘₐₓ is true; if yes, returning to the step S3; otherwise, terminating the algorithm and outputting the global optimal solution gbest, and outputting optimal job assignment, job batching, batch processing order and starting time of maintenance on each machine.

2. The method according to claim 1, wherein calculating the fitness value of each nectar source in the solution set in the step S3 comprises:
step S31, successively assigning the jth job to machine x_{q}^{j} according to a code rule first, and on each machine, sorting the jobs in a non-decreasing order by the general processing time;
step S32, on each machine, arranging first
$${n}_{i} - ( ⌈ \frac{{n}_{i}}{c} ⌉ - 1 ) c$$
jobs into a first batch and deleting such jobs from a job list; then arranging first c jobs in the remaining list into a batch and deleting such jobs from the job list, and so on, until all jobs in the job list are arranged completely, wherein nᵢ represents the number of jobs on the ith machine, while c represents the number of jobs that a machine is able to process simultaneously, and
$$⌈ \frac{x}{y} ⌉$$
represents the smallest integer that is not less than
$$\frac{x}{y} ;$$
step S33, setting parameter e=1, indicating that maintenance is started after the completion of processing of the first job;
step S34, with regard to each machine, calculating
$${w}_{hi} = \{ \begin{matrix}( {d}_{i} + 1 ) {( β + 1 )}^{e - h} h = 1 , 2 , 3 … , e \\ {( β + 1 )}^{e - h} h = 1 , 2 , 3 , … , {B}_{i}\end{matrix} , i = 1 , … , m ,$$
wherein Bᵢ represents the total number of batches on the ith machine;
step S35, sorting all batches on each machine in a non-decreasing order by processing time, arranging the first batch in a position with the maximum value of wₕᵢ, i.e., arranging the first job to be processed as the hth one, and deleting this batch and wₕᵢ from the list; and repeating this operation until each batch corresponds to the processing order one to one; and
step S36, calculating completion time Cₘₐₓⁱ(e) on each machine; let e=e+1, determining whether e≤Bᵢ is true; if yes, returning to the step S34; otherwise, confirming on the machine that maintenance is started after the completion of processing of the (L*)th job, wherein L*=Arg max_{L=1,2, . . . ,B}_{ᵢ}{Cₘₐₓⁱ(L)}, i.e., arranging the position with the shortest processing time among all positions to be the position of maintenance, and terminating the algorithm.

3. The method according to claim 1, wherein the step S5 comprises:
step S51, obtaining a nectar source code, and generating a random number rand between 0 and 1;
step S52, determining whether rand<Rₐ is true; if yes, performing step S53; otherwise, performing step S54;
step S53, randomly generating two positive integers x and y between 1 and n, and interchanging numerical values corresponding to the xth and yth positions in the nectar source, thereby obtaining a new nectar source position code; and
step S54, randomly generating two positive integers x and y between 1 and n, and reversing a sequence between the xth and yth position, thereby obtaining a new nectar source position code.

4. The method according to claim 1, wherein the step S7 comprises:
step S71, obtaining a nectar source code as current optimal solution, and defining iterations it max, tabu list length tabulong, and neighborhood searches Slong;
step S72, randomly generating two positive integers x and y between 1 and n, moving the numerical value of the xth position to the yth position, and then arranging numerical values between the (x+1)th and the yth position to the xth to (y−1)th positions of a new code, thereby obtaining a new nectar source code;
step S73, repeating the step S72 until Slong new nectar source codes are generated, and calculating the fitnesses of all solutions;
step S74, comparing the solution with the best fitness with the current optimal solution; if the solution with the best fitness is superior to the current optimal solution, performing step S76; otherwise, performing step S75;
step S75, sorting all the solutions in a descending order, successively checking whether the corresponding x and y values of the solutions are present in the tabu list until the result for a solution is no, and then performing step S76 with the solution as the best-fit solution;
step S76, replacing the current optimal solution with the best-fit solution; determining whether the number of records in the tabu list is greater than tabulong; if yes, deleting the last element in the tabu list, moving each element down by one position, and adding the x and y values corresponding to the best-fit solution to the first position of the tabu list; otherwise, directly moving each element down by one position, and adding the x and y values corresponding to the best-fit solution to the first position of the tabu list; and
step S77, with it=it+1, determining whether it≤it max is true; if yes, returning to the step S72; otherwise, terminating search.

5. A production scheduling system based on an improved artificial bee colony algorithm, wherein the system comprises a computer, comprising:
at least one storage unit;
at least one processing unit; and
at least one output unit;
wherein the at least one storage unit stores at least one instruction to be loaded and executed by the at least one processing unit to implement the following steps:
S1, inputting the capacity of each machine and general processing time for a job, and setting parameters of the improved artificial bee colony algorithm, including maximum iterations tₘₐₓ, global optimal solution gbest, nectar source search limit UP, number of employed bees SN, and iteration t=1;
S2, initializing the population with consideration of total SN nectar sources, with the position of the qth nectar source being defined as X_{q}=(x_{q}¹, x_{q}², . . . , x_{q}^{j}, . . . , x_{q}ⁿ), q=1, 2, . . . , SN, wherein, . . . , represents the position of the qth nectar source in the jth dimension, indicating that the jth job is assigned to machine x_{q}^{j};
S3, calculating a fitness value of each nectar source in a solution set, and updating the global optimal solution gbest;
S4, calculating neighborhood selection probability
$${R}_{a} = \frac{t}{{t}_{max}}$$
of the current generation, by setting the variable q=1;
S5, determining whether rand(0,1)≤Rₐ is true; if yes, performing an exchange mutation operation on X_{q}, and retaining the nectar source according to a greedy rule, wherein rand(0,1) represents a random number between 0 and 1; otherwise, performing an inversion mutation operation on X_{q}, and retaining nectar source according to the greedy rule; if the nectar source is updated, up_{q}=0; otherwise, up_{q}=up_{q}+1, wherein up_{q} represents searches for the qth nectar source;
S6, with q=q+1, determining whether q≤SN is true; if yes, returning to the step S5; otherwise, performing step S7;
S7, calculating probability
$${pro}_{q} = \frac{1 \text{/} {fit}_{q}}{{\sum }_{z = 1}^{SN} 1 \text{/} {fit}_{z}} ,$$
wherein fit_{q} represents the fitness value of the qth nectar source, and smaller fit_{q} indicates a better solution since the problem to be solved is a minimization problem;
S8, selecting the qth nectar source from the population with the probability pro_{q}, and performing a tabu search operation; if the nectar source is updated, up_{q}=0; otherwise, up_{q}=up_{q}+1; repeating this operation SN times to update the solution set;
S9, setting the variable q=1;
S10, if up_{q}≤UP, q=q+1; otherwise, replacing X_{q} with a randomly generated new solution, and let up_{q}=0, q=q+1;
S11, determining whether q≤SN is true; if yes, returning to the step S10; otherwise, performing step S12; and
S12, replacing later 20% nectar sources in the solution set with randomly generated nectar sources; let t=t+1; determining whether t≤tₘₐₓ is true; if yes, returning to the step S3; otherwise, terminating the algorithm; and
the at least one output unit is configured to output the global optimal solution gbest, and output optimal job assignment, job batching, batch processing order and starting time of maintenance on each machine.

6. The system according to claim 5, wherein in the step S3 implemented through loading and execution of the at least one instruction by the at least one processing unit, the process of calculating the fitness value of each nectar source in the solution set comprises:
step S31, successively assigning the jth job to machine x_{q}^{j} according to a code rule first, and on each machine, sorting the jobs in a non-decreasing order by the general processing time;
step S32, on each machine, arranging first
$${n}_{i} - ( ⌈ \frac{{n}_{i}}{c} ⌉ - 1 ) c$$
jobs into a first batch and deleting such jobs from a job list; then arranging first c jobs in the remaining list into a batch and deleting such jobs from the job list, and so on, until all jobs in the job list are arranged completely, wherein nᵢ represents the number of jobs on the ith machine, while c represents the number of jobs that a machine is able to process simultaneously, and
$$⌈ \frac{x}{y} ⌉$$
represents the smallest integer that is not less than
$$\frac{x}{y} ;$$
step S33, setting parameter e=1, indicating that maintenance is started after the completion of processing of the first job;
step S34, with regard to each machine, calculating
$${w}_{hi} = \{ \begin{matrix}( {d}_{i} + 1 ) {( β + 1 )}^{e - h} h = 1 , 2 , 3 … , e \\ {( β + 1 )}^{e - h} h = 1 , 2 , 3 , … , {B}_{i}\end{matrix} , i = 1 , … , m ,$$
wherein Bᵢ represents the total number of batches on the ith machine;
step S35, sorting all batches on each machine in a non-decreasing order by processing time, arranging the first batch in a position with the maximum value of wₕᵢ, i.e., arranging the first job to be processed as the hth one, and deleting this batch and wₕᵢ from the list; and repeating this operation until each batch corresponds to the processing order one to one; and
step S36, calculating completion time Cₘₐₓ^{j}(e) on each machine; let e=e+1, determining whether e≤Bᵢ is true; if yes, returning to the step S34; otherwise, confirming on the machine that maintenance is started after the completion of processing of the (L*)th job, wherein L*=Arg max_{L=1,2, . . . ,B}_{ᵢ}, {Cₘₐₓⁱ(L)}, i.e., arranging the position with the shortest processing time among all positions to be the position of maintenance, and terminating the algorithm.

7. The system according to claim 5, wherein the step S5 implemented through loading and execution of the at least one instruction by the at least one processing unit comprises:
step S51, obtaining a nectar source code, and generating a random number rand between 0 and 1;
step S52, determining whether rand<Rₐ is true; if yes, performing step S53; otherwise, performing step S54;
step S53, randomly generating two positive integers x and y between 1 and n, and interchanging numerical values corresponding to the xth and yth positions in the nectar source, thereby obtaining a new nectar source position code; and
step S54, randomly generating two positive integers x and y between 1 and n, and reversing a sequence between the xth and yth position, thereby obtaining a new nectar source position code.

8. The system according to claim 5, wherein the step S7 implemented through loading and execution of the at least one instruction by the at least one processing unit comprises:
step S71, obtaining a nectar source code as current optimal solution, and defining iterations it max, tabu list length tabulong, and neighborhood searches Slong;
step S72, randomly generating two positive integers x and y between 1 and n, moving the numerical value of the xth position to the yth position, and then arranging numerical values between the (x+1)th and the yth position to the xth to (y−1)th positions of a new code, thereby obtaining a new nectar source code;
step S73, repeating the step S72 until Slong new nectar source codes are generated, and calculating the fitnesses of all solutions;
step S74, comparing the solution with the best fitness with the current optimal solution; if the solution with the best fitness is superior to the current optimal solution, performing step S76; otherwise, performing step S75;
step S75, sorting all the solutions in a descending order, successively checking whether the respective x and y values of the solutions are present in the tabu list until the result for a solution is no, and then performing step S76 with the solution as the best-fit solution;
step S76, replacing the current optimal solution with the best-fit solution; determining whether the number of records in the tabu list is greater than tabulong; if yes, deleting the last element in the tabu list, moving each element down by one position, and adding the x and y values corresponding to the best-fit solution to the first position of the tabu list; otherwise, directly moving each element down by one position, and adding the x and y values corresponding to the best-fit solution to the first position of the tabu list; and
step S77, with it=it+1, determining whether it≤it max is true; if yes, returning to the step S72; otherwise, terminating search.

9. A computer-readable storage medium that stores at least one instruction to be loaded and executed by a processor to implement the method of claim 1.
